(19) United States
(12) Patent Application Publication
(10) Pub. No.: US 2015/0173378 A1
(43) Pub. Date: Jun. 25, 2015

(54) APPARATUS FOR SHUCKING SHELLFISH

(71) Applicant: Randolph E. Payne, Mechanicsville, MD (US)

(72) Inventor: Randolph E. Payne, Mechanicsville, MD (US)

(21) Appl. No.: 14/576,767

(22) Filed: Dec. 19, 2014

Related U.S. Application Data
(60) Provisional application No. 61/919,214, filed on Dec. 20, 2013.

(51) Int. Cl. A22C 29/04; A47G 21/06

(52) U.S. Cl. CPC A22C 29/046; A47G 21/065

(57) ABSTRACT

The invention includes an apparatus for opening shellfish including one or more improvements. The apparatus comprises a base and an elongated lever pivotally attached to the base with a wedge member attached to the lever, and also may include one or more of the following features: (1) a means for adjusting the location at which the lever is pivotally attached to upwardly projecting portions of the base so as to facilitate opening shellfish of varying sizes, (2) a plate with grooves on both sides that rests on the base and helps hold the shellfish in position when being opened that is removable, thereby facilitating cleaning of the plate and providing other advantages, and (3) a wedge member that mates with the seam between the shells of shellfish that is substantially in the shape of a triangular prism with two concave faces that contact the shellfish when in operation.

### CROSS-REFERENCE TO RELATED APPLICATION

This application claims the benefit of U.S. Provisional Application No. 61/919,214, filed on Dec. 20, 2013, the contents of which are incorporated herein by reference.

### FIELD OF THE INVENTION

This invention pertains to the field of shucking shellfish.

### BACKGROUND OF THE INVENTION

Various apparatuses for shucking shellfish exist. For example, U.S. Pat. No. 4,348,788 describes an oyster opener in which a base is provided with a roughened surface portion and a raised mounting point for an elongated lever. The elongated lever has one end pivotally anchored to the mounting point and a handle at the other end of the lever. An intermediate portion of the lever having a downwardly tapered wedge member attached thereto is disposed over the roughened surface portion. To operate the apparatus disclosed in U.S. Pat. No. 4,348,788, a shellfish such as an oyster is held by an operator's hand in an upright position on the roughened surface portion, and the lever is lowered until the wedge member contacts the seam between the two shells of the oyster. The operator's hand is then removed from the oyster, and the lever is lowered further such that the wedge member separates the two shells and thereby opens, or “shucks” the oyster.

Other generally similar apparatuses are described in U.S. Pat. Nos. 5,482,500, 7,393,270 and D342,870.

The existing apparatuses for shucking shellfish have certain drawbacks. For example, the existing apparatuses have limited adjustability, and thus may be difficult to use when opening shellfish of differing sizes. In addition, the roughened surface portion in the existing apparatuses that have a roughened surface portion may be difficult to clean and may suffer from wear and tear. Finally, the wedge members of the existing apparatuses have shapes that may hamper the effectiveness of the apparatus in opening shellfish.

### SUMMARY OF THE INVENTION

The present invention addresses the drawbacks of existing apparatuses for opening (or shucking) shellfish.

In accordance with one aspect of the present invention, an apparatus for opening shellfish includes an elongated lever pivotally and removably attached to each of two upwardly projecting portions of a base. Preferably, each of the upwardly projecting portions comprises multiple connection points, so that the location at which the elongated lever is pivotally and removably attached to the upwardly projecting portions can be quickly adjusted, thus facilitating the opening of shellfish of differing sizes.

In accordance with a second aspect of the present invention, a removable plate having one or more grooves to be used in an apparatus for opening shellfish is provided. Preferably, the removable plate has a plurality of grooves on each of a first side and a second side of the plate. Such features facilitate cleaning of the removable plate, permit the removable plate to last longer, and permit replacement of the removable plate when needed.

The present invention also includes a wedge member with a concave shape on one or more faces that is especially suitable for shucking shellfish.

### BRIEF DESCRIPTION OF THE DRAWINGS

Specific examples have been chosen for purposes of illustration and description, and are shown in the accompanying drawings, forming a part of the specification.

FIG. 1 illustrates one view of an embodiment of the present invention.

FIG. 2 illustrates another view of an embodiment of the present invention.

FIG. 3a illustrates an embodiment of a removable plate of the present invention having grooves on each side.

FIG. 3b illustrates a side view of a removable plate of the present invention having grooves on each side.

FIG. 4 illustrates an embodiment of the wedge member of the present invention.

### DETAILED DESCRIPTION

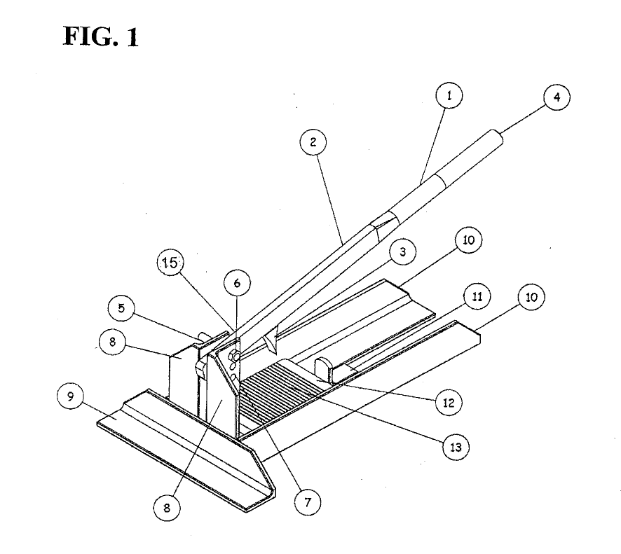

FIG. 1 depicts a preferred embodiment of an apparatus of the present invention. An elongated lever 4 includes a handle portion 1, an intermediate portion 2, and a pivot portion 15. The intermediate portion is between the handle portion and the pivot portion. Wedge member 3 is attached to intermediate portion 2. Pivot portion 15 is pivotally attached to two portions 8 of a base that project upwards. Each upwardly projecting portion 8 of the base has multiple holes 7 in it. The holes 7 in one upwardly projecting portion 8 are directly opposite the holes 7 in the other upwardly projecting portion 8 (e.g., the holes 7 in one upwardly projecting portion 8 are in the same horizontal plane as the holes 7 in the other upwardly projecting portion 8). The elongated lever 4 has a hole in it on the pivot portion 15. In an especially preferred embodiment, the elongated lever 4 is pivotally attached to the upwardly projecting portions 8 of the base by putting a bolt 6 through a hole 7 on one upwardly projecting portion 8, then through the hole of the lever 4, and then through the corresponding hole 7 on the other upwardly projecting portion 8. The bolt 6 is secured to the upwardly projecting portions 8 with a nut (such as a wing nut) attached to the end 5 of the bolt that was pushed through the holes.

The base of the apparatus includes upwardly projecting portions 8, front portion 9, lateral portions 10 and stopper 11. The upwardly projecting portions 8, front portion 9, and lateral portions 10 are all permanently affixed to one another. Stopper 11 is permanently affixed to lateral portions 10. These portions of the base may originally be separate pieces of material that are permanently affixed to one another by techniques known to those skilled in the art, such as welding. Alternatively, the base may originally be one piece of material that includes upwardly projecting portions 8, front portion 9, lateral portions 10 and stopper 11. The base need not include each of upwardly projecting portions 8, front portion 9, lateral portions 10 and stopper 11, but rather need only include portions necessary to serve its intended purpose. The bottom surface of the base is the surface of the apparatus that contacts the surface on which the apparatus rests (such as a table). One or more foam or rubber pads (not shown) may be attached to the bottom surface of the base to keep the apparatus from slipping when in operation.

A removable plate 12 rests on the base between the stopper 11, the lateral portions 10, and upwardly projecting portions 8. This removable plate is generally flat, and has one or more grooves 13 on at least one of the flat sides. Preferably, the removable plate has a plurality of grooves on each flat side. In the embodiment shown in FIG. 1, there is not very much space between the edges of the removable plate 12, and the face of the stopper 11, the faces of the lateral portions 10, and the faces of the upwardly projecting portions 8 that are closest to the edges of the removable plate 12. This keeps the removable plate from sliding around when the apparatus is being used to shuck shellfish.

The wedge member 3 is substantially in the shape of a triangular prism. However, at least one face of the wedge member that contacts the shellfish when in operation is concave, and preferably two faces of the wedge member that contact the shellfish when in operation are concave. In fine cutlery, this shape (with two concave faces) is sometimes referred to as a “hollow grind.” This shape allows the wedge member 3 to penetrate the shellfish quickly, and accelerates the opening of the shellfish.

In operation, a shellfish such as an oyster is held by an operator's hand in an upright position with one end resting on the grooves 13 of the removable plate 12, and the other end pointing upwards. The elongated lever 4 is then lowered until the tip of the wedge member 3 contacts the seam between the two shells of the oyster. The present inventor has discovered that it is preferable to orient the oyster in the apparatus so that the “hinge” of the oyster (the side away from the side that opens up, which is referred to as the “bill” of the oyster) is facing upwards toward the wedge member. The operator's hand is then removed from the oyster, and the lever 4 is lowered further, with the wedge member 3 (with its “hollow grind” shape) separating the two shells and thereby opening (or shucking) the oyster. The grooves help to hold the oyster in place (and keep it from sliding out from under the wedge member) after the hand is removed from the oyster. In this way, the oyster is not being held by the operator's hand when the wedge opens the oyster, which thereby minimizes the possibility of injury to the hands, which is a major problem when shucking shellfish such as oysters.

One advantage of the embodiment of the present invention depicted in FIG. 1 is that the location at which the elongated lever 4 is pivotally attached to the upwardly projecting portions 8 of the base may be adjusted by changing the holes 7 on the upwardly projecting portions 8 that are used in pivotally attaching the lever 4 to the upwardly projecting portions 8. The holes 7 may be arranged in a generally vertical pattern, as shown in FIG. 1. With this pattern, the upper-most holes may be used when opening larger shellfish, and the lower-most holes may be used when opening smaller shellfish. This permits the lever to be generally horizontal and the wedge member 3 to be pointing generally straight downwards when the wedge member first contacts the seam between the shells of various sizes of shellfish, and thus allows the wedge member to easily open a greater variety of sizes of shellfish. This also reduces the frequency with which the shellfish slide out from under wedge member 3 without being opened when the lever 4 is moved downwards to open the shellfish since such sliding is more likely to happen when the wedge member is not pointing generally straight downwards when it first contacts the seam between the shells of shellfish. The nut that mates with the bolt 6 may be of a type that can be easily screwed on and screwed off, such as a wing nut, to facilitate frequent and quick adjustment of the location at which the elongated lever 4 is pivotally attached to the upwardly projecting portions 8 of the base. Although the embodiment depicted in FIG. 1 has two upwardly projecting portions, other variations are within the scope of the present invention, such as embodiments with one upwardly projecting portion, or three or more upwardly projecting portions. The key to this particular feature is having multiple attachment points on the upwardly projecting portion(s) at which the pivot portion of the lever may be pivotally attached to the base. In the embodiment depicted in FIG. 1, the pivot portion of the lever is pivotally and removably attached to the upwardly projecting portions by way of a bolt, nut and holes in the lever and upwardly projecting portions. However, the pivot portion of the lever may be pivotally and removably attached to the upwardly projecting portions(s) using any technique known to those skilled in the art.

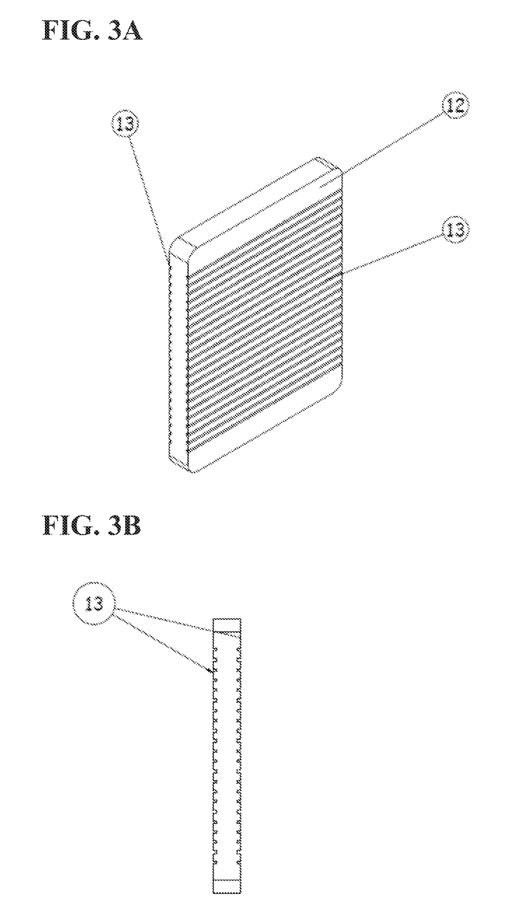

Another advantage of the embodiment of the present invention depicted in FIG. 1 is that removable plate 12 is removable, and has grooves 13 on both sides (as depicted in FIG. 3a and FIG. 3b). The fact that the removable plate 13 is removable makes it much easier to clean, which is important because material from shellfish that have been opened with the apparatus (such as pieces of shell, portions of the shellfish themselves, and juice) tend to accumulate on the grooves. The fact that the removable plate has grooves on both sides helps make the grooves 13 last longer. The friction between the rough, hard shell of a shellfish and the grooves 13 on removable plate 12 will cause wear and tear on the grooves 13. But since the grooves 13 are on both sides, they need only be used half as often, and should last twice as long. The fact that the removable plate is removable makes it easier to replace the removable plate when necessary. The fact that the removable plate is removable is also an advantage because the removable plate, which is one of the parts of the apparatus that actually contacts the shellfish, may be made of a material that is appropriate for use with food products (such as stainless steel), while other parts of the apparatus that do not come into contact with the shellfish, such as the base, may be made of a different material (such as aluminum). This is advantageous because materials that are appropriate for use with food products (such as stainless steel) may be more expensive than other materials (such as aluminum) that may be used to make other portions of the apparatus, such as the base. The lever and wedge may also be made of a material (like stainless steel) that is appropriate for use with food products, since the wedge is the other part of the apparatus (along with the removable plate) that actually contacts the shellfish. The wedge and removable plate are also the parts of the device that experience the greatest wear and tear (since they actually come into contact with the shellfish), which is another reason why it may be appropriate to make them of a material that is more resistant to wear and tear (like stainless steel) than other parts of the apparatus, like the base, that do not actually come into contact with the shellfish, which can thus be made of a material that is less resistant to wear and tear (like aluminum).

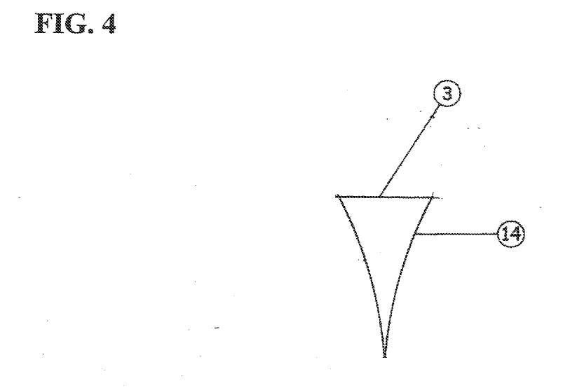

Another advantage of the embodiment of the present invention depicted in FIG. 1 is the shape of the wedge member 3. As described above, the wedge member is substantially in the shape of a triangular prism. However, the faces of the prism that contact the shellfish when in operation may both be concave. This shape allows the wedge member 3 to penetrate the shellfish quickly, and accelerates the opening of the shellfish. This shape is also depicted in FIG. 4.

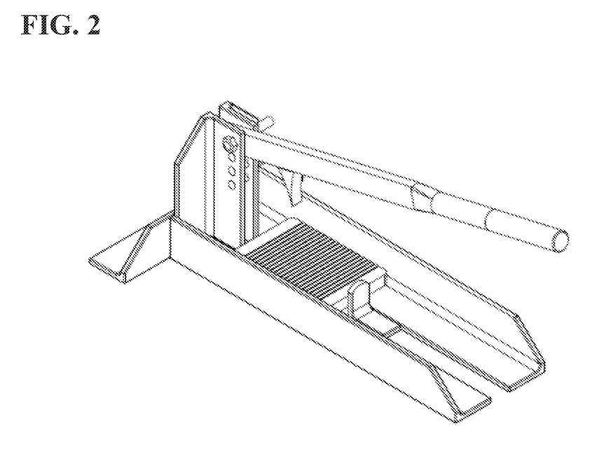

FIG. 2 depicts the embodiment of the invention depicted in FIG. 1, but from a different perspective.

FIG. 3a depicts an embodiment of the removable plate 12, with grooves 13 on each side. FIG. 3b is a different perspective of the removable plate, showing the generally rectangular shape of the grooves in one embodiment. The grooves may be any shape that helps hold the shellfish in place during the shucking procedure, such as rectangular-shaped or wedge-shaped.

FIG. 4 depicts the wedge member 3. As can be seen, each face 14 of the wedge member that contacts the shellfish when in operation is concave-shaped. The concave shape allows the wedge member 3 to penetrate the shellfish quickly, and accelerates the opening of the shellfish.

An apparatus for opening shellfish need not have each of the features described herein to fall within the scope of the present invention. For example, an apparatus for opening shellfish including means for adjusting the location at which the lever is pivotally and removably attached to the upwardly projecting portions, but not including a removable plate with grooves on each side or a wedge member with two concave faces, would fall within the scope of the present invention. Similarly, an apparatus for opening shellfish including a removable plate with grooves on each side, but not including means for adjusting the location at which the lever is pivotally and removably attached to the upwardly projecting portions or a wedge member with two concave faces, would fall within the scope of the present invention. Similarly, an apparatus for opening shellfish including a wedge member with two concave faces, but not including means for adjusting the location at which the lever is pivotally and removably attached to the upwardly projecting portions or a removable plate with grooves on each side, would fall within the scope of the present invention.

The present invention may be used to open (or shuck) any type of shellfish, including but not limited to oysters, clams, mussels, and stone crabs (including the claws in particular).

From the foregoing, it will be appreciated that although specific examples have been described herein for purposes of illustration, various modifications may be made without deviating from the spirit or scope of this disclosure. It is therefore intended that the foregoing detailed description be regarded as illustrative rather than limiting, and that it be understood that it is the following claims, including all equivalents, that are intended to particularly point out and distinctly claim the claimed subject matter.

1. An apparatus for opening shellfish comprising:
a base having one or more upwardly projecting portions having a plurality of attachment points;
a lever having a pivot portion, an intermediate portion, and a handle portion, the intermediate portion being located between the pivot portion and the handle portion;
the pivot portion being pivotally and removably attached to a first attachment point on a first upwardly projecting portion;
the pivot portion being configured to be pivotally and removably attached to a second attachment point on the first upwardly projecting portion; and
a wedge member attached to the intermediate portion.

2. The apparatus of claim 1, wherein said base has a second upwardly projecting portion having a plurality of attachment points.

3. The apparatus of claim 2, wherein the pivot portion is disposed between the first upwardly projecting portion and the second upwardly projecting portion.

4. The apparatus of claim 3, wherein the pivot portion is pivotally and removably attached to a first attachment point on the second upwardly projecting portion.

5. The apparatus of claim 4, wherein the second upwardly projecting portion has a second attachment point, and the lever is configured to be removable from the first attachment point of the first upwardly projecting portion and the first attachment point of the second upwardly projecting portion, and reattached to the second attachment point of the first upwardly projecting portion and the second attachment point of the second upwardly projecting portion.

6. The apparatus of claim 1, wherein each of the plurality of attachment points are holes.

7. The apparatus of claim 6, wherein the pivot portion is pivotally and removably attached to the first attachment point of the first upwardly projecting portion with a bolt and a nut.

8. The apparatus of claim 1, further comprising a removable plate configured to rest on the base having a plurality of grooves on at least a first side.

9. The apparatus of claim 1, wherein the wedge member is substantially in the shape of a triangular prism, and has at least one face configured to contact the shellfish when in operation that is concave.

10. The apparatus of claim 8, wherein the wedge member is substantially in the shape of a triangular prism, and has at least one face configured to contact the shellfish when in operation that is concave.

11. An apparatus for opening shellfish comprising:
a base having one or more upwardly projecting portions that have at least one attachment point;
a lever having a pivot portion, an intermediate portion, and a handle portion, the intermediate portion being located between the pivot portion and the handle portion;
the pivot portion being pivotally attached to a first attachment point on a first upwardly projecting portion;
a wedge member attached to the intermediate portion; and
a removable plate configured to rest on the base having a plurality of grooves on at least a first side.

12. The apparatus of claim 11, wherein the removable plate has grooves on a second side opposite to the first side.

13. The apparatus of claim 11, wherein the removable plate is made of a material that is appropriate for use with food products, while other portions of the apparatus are made of a different material.

14. The apparatus of claim 11, wherein the grooves are rectangular-shaped.

15. The apparatus of claim 11, wherein the grooves are wedge-shaped.

16. The apparatus of claim 11, wherein the base is configured to prevent the removable plate from sliding when the apparatus is used to open shellfish.

17. The apparatus of claim 11, wherein the wedge member is substantially in the shape of a triangular prism, and has at least one face configured to contact the shellfish when in operation that is concave.

18. An apparatus for opening shellfish comprising:
a base having one or more upwardly projecting portions that have at least one attachment point;
a lever having a pivot portion, an intermediate portion, and a handle portion, the intermediate portion being located between the pivot portion and the handle portion;
the pivot portion being pivotally attached to a first attachment point on a first upwardly projecting portion; and
a wedge member attached to said intermediate portion;
wherein the wedge member is substantially in the shape of a triangular prism, and has at least one face configured to contact the shellfish when in operation that is concave.

19. The apparatus of claim 18, wherein the wedge member has at least two faces configured to contact the shellfish when in operation that are concave.

20. The apparatus of claim 18, wherein the wedge member has a hollow grind shape.
